(19) United States
(12) Patent Application Publication
(10) Pub. No.: US 2025/0059750 A1
(43) Pub. Date: Feb. 20, 2025

(54) TOUCHLESS TOILET SEAT CLEANING

(71) Applicant: Abdalsalam Mohammed Abdalla, Sulaimaniyah (IQ)

(72) Inventor: Abdalsalam Mohammed Abdalla, Sulaimaniyah (IQ)

(21) Appl. No.: 18/450,773

(22) Filed: Aug. 16, 2023

(51) Int. Cl. E03D 9/00; B08B 3/02; B08B 3/08; B08B 13/00

(52) U.S. Cl. CPC E03D 9/002; B08B 3/02; B08B 3/08; B08B 13/00

(57) ABSTRACT

Obviously, Toilets are public sanitary ware, and to protect health that is important to ensure that they are always clean and ready for reuse.

Just using this invention the Touchless Toilet Seat Cleaning for our toilets makes our Toilets cleaner and healthier, and a reason to protect our health.

This is the main reason for the desire to development and innovation of a method for washing, cleaning and drying the Toilet Seat to be so important, The Control Board organizes and controls the steps of washing, cleaning and drying the Toilet Seat completely through its Toilet Seat Cover, by using soap or any suitable chemical liquid, water and hot air, when soap is first sprayed on the Toilet Seat for washing and then using high pressure water for cleaning, at the end is using the hot air to drying the Toilet Seat, these steps are automatically arranged and sequential, finally a Toilet Seat is ready for reuse in a short time.

### CROSS-REFFERENCE TO RELATED APPLICATIONS

This Non-Provisional Utility application claims the benefit of Kurdistan Innovation Institute of Iraq Non-Disclosure Agreement (NDA), filed Dec. 11, 2022 & Jan. 16, 2023, which is incorporated by reference herein in its entirety.

### BACKGROUND OF THE INVENTION

### 1—Field of the Invention

Touchless Toilet Seat Cleaning System is providing dispensing high pressure Soap or any chemical liquid, Water and Hot Air dry to carry out the steps of washing, cleaning and drying of the Toilet Seat via the Toilet Seat Cover and the Control Board automatically.

### 2—Description of the Related Art

Toilet Seats are the good medium for direct contact and transmission of many different types of virus and germs from one person to another, so the desire to development and innovate of a new method to washing, cleaning and drying the Toilet Seats are very important, like as Touchless Toilet Seat Cleaning System.

### BRIEF SUMMARY OF THE INVENTION

Touchless Toilet Seat Cleaning consists of three main parts: Control Board, Toilet Seat and Toilet Seat Cover, these parts work together independently where the Control Board is used to control and organize the steps of washing, cleaning and drying the Toilet Seat via Toilet Seat Cover.

Touchless Toilet Seat Cleaning distinguished by the fact that all Toilet brands in the world can benefit to use this innovation to clean their Toilet Seats by installing the Touchless Toilet Seat Cleaning parts on their Bowls.

### BRIEF DESCRIPTION OF THE DRAWINGS

FIG. 1 Touchless Toilet Seat Cleaning.

FIG. 2 Control Board, Toilet Seat and Toilet Seat Cover installed on the Toilet Bowl.

### DETAILED DESCRIPTION OF THE INVENTION

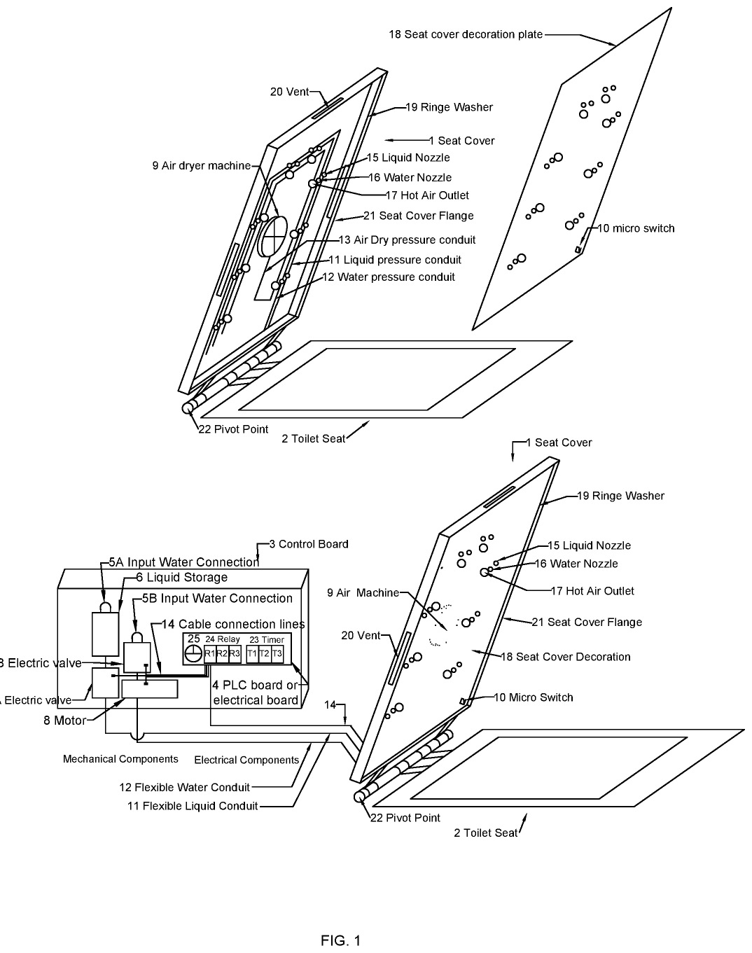

Touchless Toilet Seat Cleaning System is providing dispensing high pressure Soap or any chemical liquid, Water and Hot Air dry to carry out the steps of washing, cleaning and drying of the Toilet Seat via the Toilet Seat Cover and the Control Board, One of the endings of the Flexible liquid conduit (11) is connected to Liquid storage (6) via of electrical valve (7A) in the control board (3), the other endings of the Flexible Liquid conduit (11) are also installed on the (right side, left side and front side) of the Seat Cover (1). As illustrated in FIG. 1.

One of the endings of the Flexible Water conduit (12) is connected to Input Water Connection (5B) in the method of Motor (8) and Electrical Valve (7B) in the Control Board (3), the other endings of the Flexible Water Conduit (12) are also installed on the (right side, left side and front side) of the Seat Cover (1). As illustrated in FIG. 1.

The Liquid Storage (6) is connected to Input Water Connection (5A). As illustrated in FIG. 1.

The Control Board (3) is classified into two parties: Electrical components and Mechanical Components. As illustrated in FIG. 1.

The Electrical Components may be an Electrical Board or Programmable Logic Controller (PLC) Board (4) used to organize and control the Mechanical operation via Timers (23) and Relays (24) by the Cable Connection Lines (14). As illustrated in FIG. 1.

The Mechanical Components are (the Motor (8), the Electrical valves (7A, 7B), the hot Air dryer machine (9) and the Micro switch (10)). As illustrated in FIG. 1.

The Control Board (3) is connected to the Seat Cover (1) via a Flexible liquid Conduit (11), a Flexible Water Conduit (12) and an Electrical Connection Line (14). As illustrated in FIG. 1.

The Air Dryer Machine (9) is fixed on the middle of the Seat Cover (1). As illustrated in FIG. 1.

The Flexible Air Pressure Conduit (13) is installed on the (right side, left side and front side) of the Seat Cover (1). As illustrated in FIG. 1.

One of the endings of the Flexible Air Pressure conduit (13) is connected to Air dryer Machine (9) and the other endings of the Air pressure Conduit (13) is also fixed on the Seat Cover (1) too. As illustrated in FIG. 1.

The Liquid Nozzles (15) are installed on the Liquid Conduit (11) and they are divided on each one of the Right side, Left side and Front side of the Seat Cover (1). As illustrated in FIG. 1.

The Liquid Nozzles (15) are used to spray Chemical Liquid such as (Soap or any suitable chemical cleaner) on the Toilet Seat (2). As illustrated in FIG. 1.

The Water Nozzles (16) are installed on the Flexible Water Conduit (12) and they are divided on each one of the Right side, Left side and Front side of the Seat Cover (1). As illustrated in FIG. 1.

The Water Nozzles (16) are used to spraying high pressure water to washing and cleaning the Toilet Seat (2). As illustrated in FIG. 1.

The Air dry Pressure Conduit (13) has several Hot Air Outlets (17) which are divided on the right side, left side and Front side of the Seat Cover (1). As illustrated in FIG. 1).

The Hot Air Outlets (17) are used to discharge the high pressure Air to dry the wash area of the Toilet Seat (2). As illustrated in FIG. 1.

The Seat Cover Flange (21) has several Vents (20) used to ventilation where are divided on the right side, left side and front side of the Seat Cover Flange (21), Vents (20) are needed while operation the Air Dryer Machine (9). As illustrated in FIG. 1.

The Seat Cover Decoration Plate (18) is installed on the Seat Cover (1) used for covering all components where fixed on the Seat Cover (1) for decoration. As illustrated in FIG. 1.

The Ring Washer (19) is installed on the edge of the Seat Cover Decoration Plate (18) on the right side, left side, rear side and front side of the Seat Cover Flange (21). As illustrated in FIG. 1.

The Ring Washer (19) is used for preventing water or any chemical liquid leakage to the outside of the Toilet Seat (2) place. As illustrated in FIG. 1.

The Seat Cover (1) is connected with the Toilet Seat (2) at the Pivot Point (22). As illustrated in FIG. 1.

The Micro Switch (10) is fixed on the rear part of the Seat Cover Decoration Plate (18), which is connected to the Electrical Board or Programmable Logic Controller (PLC) Board (4) via Cable Connection Line (14) in the Control Board (3) to control Electrical operation circuit and Mechanical operation circuit. As illustrated in FIG. 1.

After closing the seat cover (1) on the Toilet Seat (2), the Liquid Nozzles (15), Water Nozzles (16) and Hot Air outlets (17) are using the (Soap or chemical liquid, Water, and Hot Air dry) successively to wash and dry the Toilet Seat (2) automatically by means of a Micro Switch (10) located on the rear part of the Seat Cover Decoration Plate (18), which is connected to the Electrical Board or Programmable Logic Controller (PLC) Board (4) via Cable Connection Line (14) in the Control Board (3) to control (liquid, water and air dry). As illustrated in FIG. 1.

The Selector Switch (25) is used for selecting the options of wash methods by an automatic or a manual mode to control washing steps. As illustrated in FIG. 1.

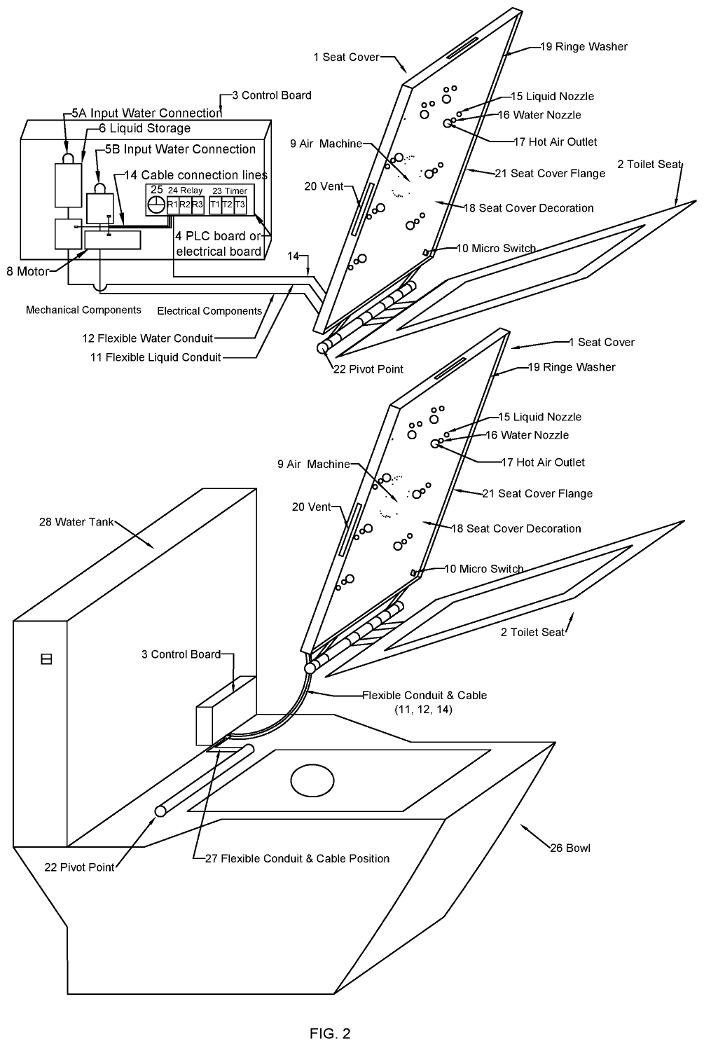

Making a new model of the toilet bowl brand according to this invention (Touchless Toilet Seat Cleaning). As illustrated in FIG. 2.

Toilet Seat (2) and Seat Cover (1) are installed on the rear part of the Toilet Bowl (26) at the Pivot Point (22). As illustrated in FIG. 2.

The Control Board (3) is fixed of the bottom part in the Water Tank (28) on the rear part of the Toilet Bowl (26). As illustrated in FIG. 2.

Liquid Conduit (11), Water Conduit (12) and Cables (14) are installed in the Conduit and Cable Position (27), they are used for connecting the Control Board (3) and Toilet Seat (2) with Seat Cover (1) together. As illustrated in FIG. 2.

All sanitary ware manufacturers can make this invention (Touchless Toilet Seat Cleaning) to their Toilet Seat brands after obtaining approval. As illustrated in FIG. 1.

The Toilets are one of the public necessities that may be the main cause of transmission of some diseases, coronavirus confirmed this risk, and today should be used the best way to clean the toilet seating areas like as (Touchless Toilet Seat Cleaning).

1. A Touchless Toilet Seat Cleaning System is providing dispensing high pressure Soap or any suitable chemical liquid, Water and Hot Air dry to carry out the steps of washing, cleaning and drying of the Toilet Seat via the Toilet Seat Cover and the Control Board automatically, Comprising:
A Control Board.
A Toilet Seat.
A toilet Seat Cover.

2. A Touchless Toilet Seat Cleaning invention used for making a new Toilet Brand by adding a Toilet Bowl, comprising: A Control Board, A Toilet Seat, A toilet Seat Cover, and A Toilet Bowl.
Where a Control Board is connected to a Toilet Seat Cover with Toilet Seat via transmittal Flexible Conduits, and Cable Connection Lines, all of them are installed on the rear part of a Toilet Bowl. The Control Board is used to organize and control the electrical and mechanical operation such as the steps of washing, cleaning, and drying the Toilet Seat automatically via the storages which are fixed in the Toilet Seat Cover and the Control Board.

3. A Touchless Toilet Seat Cleaning as defined in claim (1) means a Control Board is connected to Toilet Seat Cover with Toilet Seat via transmittal Flexible Conduits, and Cable Connection Lines. The Control Board is used to organize and control the electrical and mechanical operation such as the steps of washing, cleaning, and drying the Toilet Seat automatically via the storages which are fixed in the Toilet Seat Cover and the Control Board.

4. A Touchless Toilet Seat Cleaning as defined in claim (1) means a Toilet Seat is consisted of a Seat in various shapes and designs with a Cover Seat, and the Toilet Seat is cleaned via the Seat Cover and Control Board by steps of washing automatically to prepare and reuse.

5. A Touchless Toilet Seat Cleaning as defined in claim (1) means a Toilet Seat Cover which consists of an Air Dry Machine and several different Nozzles, the different Nozzles are connected on their conduits and used for dispensing Soap, water, and air dry respectively for the purpose of washing, cleaning and drying steps, automatically.

6. A Touchless Toilet Seat Cleaning as defined in claim (2) means a Toilet Bowl with Water Tank is connected together with a Control Board, Toilet Seat and Seat Cover for the purpose of making a new Toilet brand.
